(19) United States
(12) Patent Application Publication
(10) Pub. No.: US 2008/0046429 A1
(43) Pub. Date: Feb. 21, 2008

(54) System and method for hierarchical segmentation of websites by topic

(75) Inventors: Kunal Punera, Mountain View, CA (US); Shanmugasundaram Ravikumar, Cupertino, CA (US); Andrew Tomkins, San Jose, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/505,010

(22) Filed: Aug. 16, 2006

(51) Int. Cl. G06F 7/00

(52) U.S. Cl. 707/7

(57) ABSTRACT

An improved system and method is provided for hierarchical segmentation of websites by topic. To do so, an organization of topics may be determined within directories of a website, the hierarchical arrangement of the web pages in the website may be segmented by topic, and the segments representing regions of coherent topics in the website directory may be output. In an embodiment, a website directory may be converted into a binary tree and dynamic programming may be applied to iteratively determine whether to add a node of the tree to a segment representing a topic. A node selection cost may be evaluated to determine whether to add a node of the tree as a segment representing a topic. And a cohesiveness cost may be evaluated to determine how well a web page of the tree may be represented by its closest ancestral node that may be a segmentation point of a segment representing a topic.

### FIELD OF THE INVENTION

The invention relates generally to computer systems, and more particularly to an improved system and method for hierarchical segmentation of websites by topic.

### BACKGROUND OF THE INVENTION

As companies with major established search engines vie for supremacy, new entrants to the search business explore a range of technologies to attract users. Researchers and practitioners alike seek novel analytical approaches to improve the search experience. One promising approach that is generating significant interest is analysis at the level of websites, rather than individual web pages. There are a variety of techniques for exploiting site-level information. These include detecting multiple possibly-duplicated pages from the same site; determining entry points of a website; identifying spam and porn sites; detecting site-level mirrors, extracting site-wide templates, and visualizing content at the site level. However, none of these techniques describe the topical contents of a website including different topical content present in sub-parts of the website.

Examples of prior work using site-level information may include various website classification schemes based on features extracted from the individual web pages of a website. Such features may include the topic of each page, the internal hyperlinks on the site, the commonly link-to entry points to the site, with their anchor-text, the general external link structure, the directory structure of the site, the link and content templates present on the site, the description, title, and tags on key pages on the site, and so forth. Some of the website classification schemes may consider topics at individual web pages but they use these as features for a site level classifier. Thus they learn models for websites as a whole and unfortunately fail to consider describing the topical content for sub-parts of a website. Other prior work using site-level information may include partitioning a website into web units that may be collections of web pages. These fragments are created using heuristics based on intra-site linkages and, again, the topical structure within the website is ignored.

Other research in the area of classification of documents has included work on classification of hierarchical documents. But these classification techniques use features extracted from types of path relationships of a hierarchical structure and fail to discuss describing sub-parts of the hierarchical structure based on the classification. There has also been work on a hyper-link aware classifier operating upon documents in a graph. The hyper-link classifier may take into account the classes of neighboring documents for the purpose of classifying the documents, yet does not describe sub-parts of the graph by topical content.

What is needed is a novel framework that may comprehensively describe the topical contents of a website including different topical content present in sub-parts of the website. Such a system and method should support description of a coherent topic within a region of the website that may be topically cohesive, yet topically distinct from the description of other regions of the website.

### SUMMARY OF THE INVENTION

Briefly, the present invention may provide a system and method for hierarchical segmentation of websites by topic. In various embodiments, a client having a web browser may be operably coupled to a server that may provide segmentation services for segmenting websites by topic. The server may include an operably coupled segmentation engine for determining an organization of topics within a hierarchical arrangement of web pages and segmenting the hierarchical arrangement into sub-hierarchies representing coherent topics. The server may also include an operably coupled cost analysis engine that may determine a cost of an objective function for partitioning the hierarchical arrangement into segments that may be cohesive yet distinct from other segments. The cost analysis engine may include an operably coupled node selection cost analyzer for determining a cost of adding a sub-hierarchy of the hierarchical arrangement as a segment representing a topic, and the cost analysis engine may include an operably coupled cohesiveness cost analyzer for determining a cost of assigning a web page of the hierarchical arrangement to a sub-hierarchy representing a segment.

The present invention may also provide a framework to perform hierarchical topic segmentation for partitioning a website into topically-cohesive regions that may respect the hierarchical structure of the website. To do so, an organization of topics may be determined within directories of a website, the hierarchical arrangement of the web pages in the website may be segmented by topic, and the segments representing regions of coherent topics in the website directory may be output. In an embodiment, a website directory may be converted into a binary tree and dynamic programming may be applied to iteratively determine whether to add a node of the tree to a segment representing a topic. A node selection cost may be evaluated to determine whether to add a node of the tree as a segment representing a topic. And a cohesiveness cost may be evaluated to determine whether to assign a web page of the tree to an ancestral node that may be a segment node representing a topic.

Different variants of the node selection cost and the cohesiveness cost may be used. For instance, a node selection cost measure may be based on an information gain ratio to penalize a node that may be added as a new element of the segmentation if the node provides little information beyond its predecessor already in the segmentation solution. The cohesiveness cost measure may be based on a Kullback-Leibler divergence, a squared Euclidian distance, on a cosine cost measure, and so forth. Advantageously, the present invention may thus provide a flexible framework to allow implementations incorporating specific heuristic choices and requirements. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components in an embodiment for hierarchical segmentation of websites by topic, in accordance with an aspect of the present invention;

FIGS. 3A and 3B are illustrations depicting in an embodiment a website directory that may include sub-sites, in accordance with an aspect of the present invention;

FIG. 4 is a flowchart generally representing the steps undertaken in one embodiment for performing hierarchical topic segmentation, in accordance with an aspect of the present invention;

FIG. 5 is a flowchart generally representing the steps undertaken in one embodiment for segmenting a website into a hierarchy of subdirectories representing coherent topics, in accordance with an aspect of the present invention; and

FIG. 6 is a flowchart generally representing the steps undertaken in one embodiment for determining the overall cost of a particular segmentation of a website converted into a binary tree, in accordance with an aspect of the present invention.

### DETAILED DESCRIPTION

### Exemplary Operating Environment

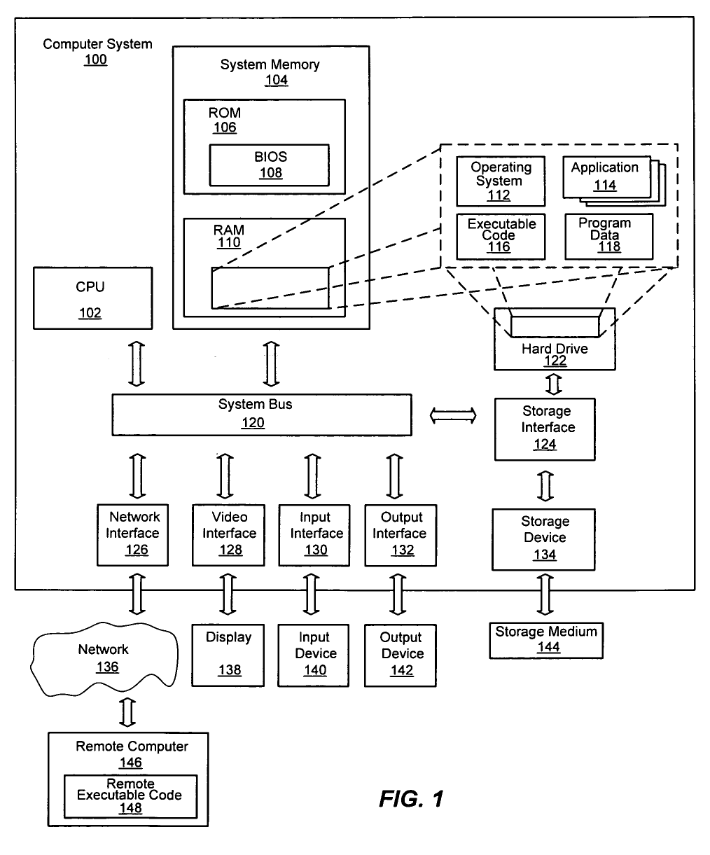

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Hierarchical Segmentation of Websites by Topic

The present invention is generally directed towards a system and method for hierarchical segmentation of websites by topic. In general, hierarchical topic segmentation may provide a segmentation of a website into topically-cohesive regions that may respect the hierarchical structure of the website and may effectively describe the topical content of the website for a user. Each page of the website may be assumed to have a topic label or a distribution on topic labels generated using a standard classifier. These distributions, along with a hierarchical arrangement of all the pages in the site, may be provided to an algorithm that may perform hierarchical segmentation of the website by topic. The algorithm may output the segments of the website representing the coherent topics, for instance, by returning a set of segmentation points that may optimally partition the site.

The present invention may also provide a set of cost measures characterizing the benefit accrued by introducing a segmentation of the website based on the topic labels. As will be seen, an objective function for the partitioning may be considered a combination of two competing costs: the cost of choosing the nodes as segmentation points and the cost of assigning the leaves to the closest chosen nodes. The node selection cost may model the requirements for a node to serve as a segmentation point, while the cohesiveness cost may model how the selection of a node as a segmentation point may improve the representation of the content with a subtree rooted at the node. As will be understood, the various block diagrams, flow charts and scenarios described herein are only examples, and there are many other scenarios to which the present invention will apply.

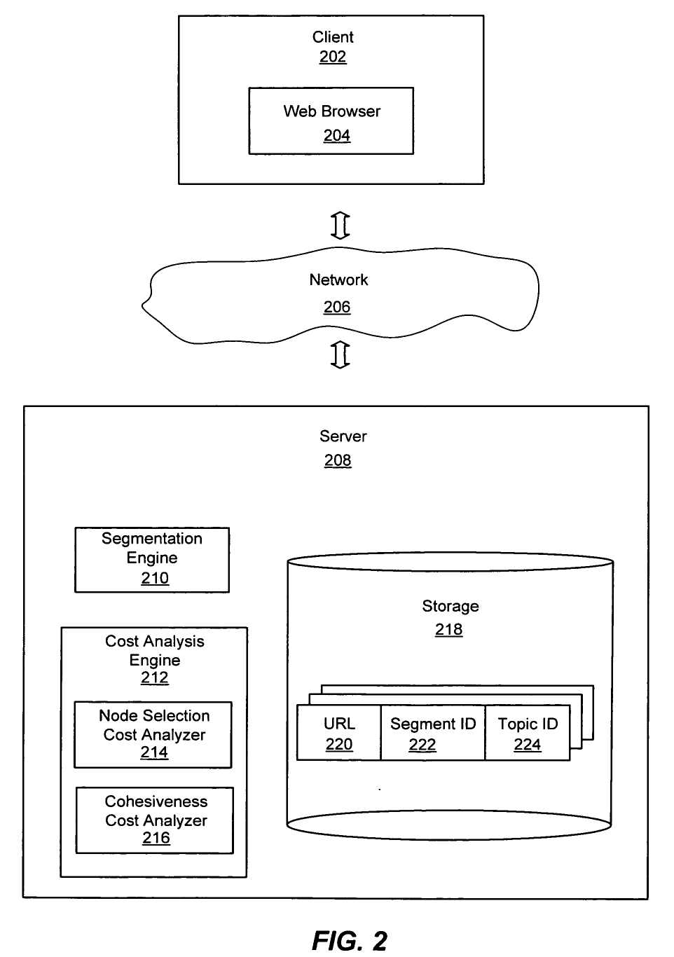

Turning to FIG. 2 of the drawings, there is shown a block diagram generally representing an exemplary architecture of system components in an embodiment for hierarchical segmentation of websites by topic. Those skilled in the art will appreciate that the functionality implemented within the blocks illustrated in the diagram may be implemented as separate components or the functionality of several or all of the blocks may be implemented within a single component. For example, the functionality for the cost analysis engine 212 may be included in the same component as the segmentation engine 210. Or the functionality of the node selection cost analyzer 214 may be implemented as a separate component from the cost analysis engine 212. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for displaying contents from website, including a directory available content or links to subdirectories of the website. The web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide segmentation services for segmenting websites by topic. The server 208 may include a segmentation engine 210 for determining an organization of topics within a website directory and segmenting the directory into subdirectories representing coherent topics. The server 210 may also include a cost analysis engine 212 that may determine a cost of an objective function for partitioning the website into segments that may be cohesive yet distinct from other segments. The cost analysis engine 212 may be operably coupled to a node selection cost analyzer 214 for determining a cost of adding a node of the website directory as a segmentation point. And the cost analysis engine 212 may also be operably coupled to a cohesiveness cost analyzer 216 for determining a cost of assigning a web page of the website directory to the closest node belonging to the segmentation solution.

Each of the analyzers and engines included in the server 208 may be any type of executable software code such as a kernel component, an application program, a linked library, an object with methods, or other type of executable software code. The server 208 may additionally be operably coupled to storage 218. The storage 218 may be any type of computer-readable media and may store information about a website directory such as a uniform resource locator (“URL”) 220, segment information such as a segment ID 222, and information about topics such as topic ID 224. In an embodiment, a record may be stored that may associate a website location such as a URL 220 with a segment ID 222 and a topic represented by the segment ID 224.

There may be a variety of applications which may use hierarchical segmentation of websites by topic. Various results that may be currently applied to websites could more naturally be applied to topically-focused segments. First of all, web search may already incorporate special treatment for pages that are known to possess a given topic—for instance, many engines provide a link to the topic in a large directory such as the Yahoo! Directory, Wikipedia, or the Open Directory Project. These approaches may naturally be extended when several pages from a search result list lie within a topically-focused segment. Second, the result segments provide a simple and concise site-level summary to help users who wish to understand the overall content and focus of a particular website. Additionally, a host such as an ISP may contain many individual websites, and a topical segmentation may provide a useful input to help determine the appropriate granularity of a site. Topical segmentation of a website may also be applicable for website classification. Website classification has been addressed using primarily manual methods since the early days of the web, in part because sites typically do not contain a single uniform class. Topical segmentation of a website may offer an important starting point for solving website classification problems.

For clarity, it may be important to note the difference between segmentation of a website and classification of a website. General website classification tries to assign topics to web sites by employing features that are broad and varied. A few example features for this broader problem may include the topic of each page, the internal hyperlinks on the site, the commonly link-to entry points to the site, with their anchor-text, the general external link structure, the directory structure of the site, the link and content templates present on the site, the description, title, and h1-6 tags on key pages on the site, and so forth. The final classes in a website classification problem may be distinct from the classes employed at the page level. Hierarchical segmentation of a website by topic, on the other hand, specifically focuses on aggregating the topic labels on web pages into subtrees according to the hierarchy of a site, in order to convey information such as, “This entire sub-site may be about Sports.” Thus, hierarchical segmentation of a website by topic may not only address the problem of determining whether and how to split the site, but may also be the beginning of a broader research problem of classifying websites using rich features. The broader problem of classifying websites may be of great interest in both binary cases (such as understanding whether the content of a website may be spam, porn, or some other category of content) and multi-class cases (such as what topics does this website represent). A solution to hierarchical segmentation of a website by topic may therefore be essential to fully address the more general site classification problem.

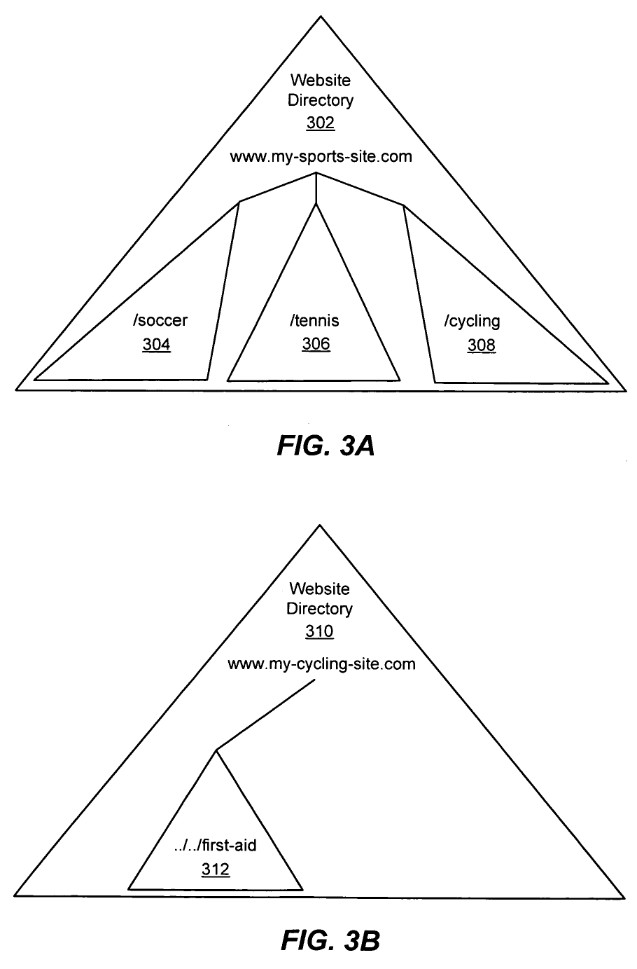

For many websites, hierarchical segmentation of a website by topic may effectively describe the topical content of the website for a user. If the website may be topically homogeneous, the URL of the website and a topic label representing the content may be provided to a user. However, most websites are not typically homogeneous, and, in fact, the organization of topics within directories may determine the best way to summarize site content for the user. For instance, consider the two hypothetical websites shown in FIGS. 3A and 3B. FIG. 3A presents an illustration depicting in an embodiment a website directory 302, www.my-sports-site.com, that may include sub-sites such as /soccer 304, tennis 306, and cycling 308. This website could be described using the top-level directories, such as www.my-sports-site.com/tennis, and for each such directory give its prevailing topic, such as Sports/Tennis. FIG. 3B presents an illustration depicting in an embodiment a website directory 310, www.my-cycling-site.com, that may include a single topically coherent tree except for a small directory, . . . / . . . /first-aid 312, that may be deep in the site structure. This website could be described as entirely about Sports/Cycling, except for a small piece at www.my-cycling-site.com/ . . . /first-aid/, which is about Health/First-Aid. As this example may show, it may be quite reasonable to describe a website using nested directories if this may be the best explanation for the content. Generally, it is desirable to make optimal use of the user's attention and convey as much information about the site as possible using the fewest possible directories, i.e., internal nodes. Hence, each directory presented to the user should provide significant additional information about the site. In addition to explaining the contents of a website to a user, other application areas listed above may leverage the same framework, but may make use of the concise segmentation of a website into topically coherent regions in other ways. In an embodiment, a website may be segmented using the directory structure of the site as a tree to constrain allowable segmentations. As will be demonstrated, such an approach works well, but it may not apply to all sites. In particular, there may be sites that contain a large number of dynamic pages with URLs of the form http://mysite.com/url.php?pageid=42. Segmentation of such sites may be possible, but may require that a hierarchy be constructed using information in addition to the internal directory structure, such as intra-site links, template structure, and so forth. Thus, a directory hierarchy may be constructed from sites with a majority of dynamic pages.

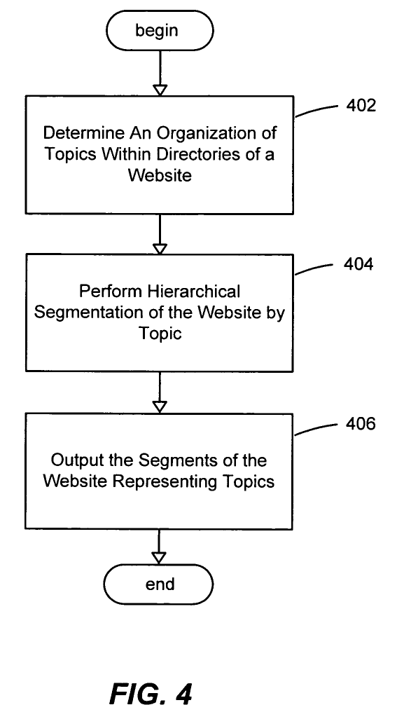

In general, hierarchical topic segmentation may provide a segmentation of a website into topically-cohesive regions that may respect the hierarchical structure of the website. FIG. 4 may present a flowchart generally representing the steps undertaken in one embodiment for performing hierarchical topic segmentation. At step 402, an organization of topics may be determined within directories of a website. Consider, for example, a tree whose leaves may have been assigned a class label or a distribution on class labels, perhaps by a standard page-level classifier in an embodiment. A distribution may then be induced on an internal node of the tree by averaging the distributions of all leaves subtended by that internal node. These distributions, along with a hierarchical arrangement of all the pages in the site, may be provided to an algorithm that may perform hierarchical segmentation of the website by topic at step 404. In an embodiment, a website may be segmented into subdirectories representing coherent topics. The algorithm may output the segments of the website representing the coherent topics at step 406, for instance, by returning a set of segmentation points that may optimally partition the site. The objective function for the partitioning may be considered a combination of two competing costs: the cost of choosing the nodes as segmentation points and the cost of assigning the leaves to the closest chosen nodes. The node selection cost may model the requirements for a node to serve as a segmentation point, while the cohesiveness cost may model how the selection of a node as a segmentation point may improve the representation of the content within the subtree rooted at the node. In an embodiment, the node selection cost may capture the requirement, for instance, that the segments may be distinct from one another and the cohesiveness cost may capture the requirement, for instance, that the segments be pure. The underlying tree structure of a website may enable an efficient polynomial-time algorithm in an embodiment to perform hierarchical segmentation of the website by topic.

More particularly, a directory structure of a website may be modeled by a rooted tree whose leaves may be individual pages. If internal nodes may also correspond to pages, internal nodes may be modeled using the standard “index.html” convention. The hierarchical structure of a website may be derived from the tree induced by the URL structure of the site, or mined from the intra-site links or the page content of the site. There may be a page-level classifier that may assign class labels or a distribution on class labels to each page of the directory structure. This may additionally induce a distribution on the internal nodes of the tree as well, by uniformly combining the distribution of all descendant pages. The notion of cohesiveness of a subtree may be based upon an agreement between each leaf with the distribution at the root of the subtree. More formally, consider T to be a rooted tree with n leaves where leaf(T) may denote the leaves of T and root(T) may denote its root. Also consider Δ to be the maximum degree of a node in T. Considering L to be the set of class labels, assume that each leaf x in the tree T may have a distribution, pₓ over L, that may have been generated by some page-level classifier. Given that pₓ(i) may denote the probability that leaf x may belong to class label i, the distribution of labels at an internal node u with leaves, leaf(u) in the subtree rooted at u, may be defined as follows:

$${p}_{u} ( i ) = \frac{1}{\vert leaf ( u ) \vert} {\sum }_{x ∈ leaf ( u )} {p}_{x} ( i )$$

A subset S of the nodes of T may be defined herein to be a segmentation of T if, for each leaf x of T, there may be at least one node y∈S, such that x may be a leaf in the subtree rooted at y. For example, S may be a segmentation if root(T)∈S. Given a parameter k, a segmentation of size at most k may be selected where each of the components may be cohesive. For a leaf, x∈leaf(T), consider Sₓ∈S to be the first element of S on the ordered path from x to root(T). In this case, x may be said to belong to Sₓ, and a cohesiveness cost d(x, Sₓ) may be defined to capture the cost of assigning x to Sₓ. Further, a node selection cost c(y,S) may be defined to give the cost of adding y to S. The overall cost of a particular segmentation S may then be defined as:

$$β {\sum }_{y ∈ S} c ( y , S ) + ( 1 - β ) {\sum }_{x ∈ leaf ( T )} d ( x , {S}_{x} ) ,$$

where β may be a constant controlling the relative importance of the node selection cost and the cohesiveness cost. The algorithms described below may then find the lowest-cost segmentation, given functions c(·) and d(·) representing the problem instance. These algorithms may be based on a general dynamic program that may optimize the objective function of

$$β {\sum }_{y ∈ S} c ( y , S ) + ( 1 - β ) {\sum }_{x ∈ leaf ( T )} d ( x , {S}_{x} ) .$$

### As those skilled in the art may appreciate, this dynamic program may work for many alternatives of cohesiveness cost d(·) and many alternatives of node selection cost c(·).

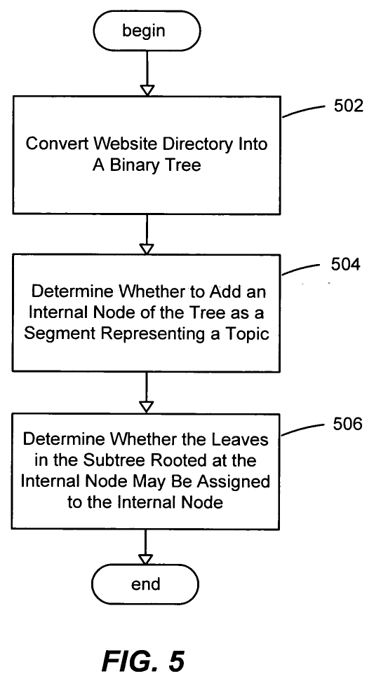

FIG. 5 presents a flowchart generally representing the steps undertaken in one embodiment for segmenting a website into a hierarchy of subdirectories representing coherent topics. At step 502, the website directory may be converted into a binary tree. Starting from root(T), a new tree may be constructed from the original tree T in the following way. Consider y to be an internal node of T with children y₁, . . . ,y_{δ} and δ>2. Then, the node y may be replaced by a binary tree of depth at most lg δ with leaves y₁, . . . , y_{δ}. The cost c(·) of y, y₁, . . . , y_{δ} may be the same as before and the cost of the newly created internal nodes may be set to ∞, in an embodiment, so that newly created internal nodes may never be selected in any solution. The process of constructing the new tree may continue by recursively applying the same steps for each of y₁, . . . , y_{δ} until the internal nodes of T may be converted to the new tree. As a result, the optimum solution of the overall cost of segmentation S on the newly constructed tree may be the same as on the original tree T. Furthermore, the size of the new tree may at most double and the depth of the tree may increase by a factor of lg Δ, where Δ may be the maximum degree of a node in T. Such a construction may be known to those skilled in the art (See, for instance, R. Fagin, R. Guha, R. Kumar, J. Novak, D. Sivakumar, and A. Tomkins, Multi-structural Databases, In Proceedings of the 24th ACM Symposium on Principles of Database Systems, pages 184-195, 2005.)

After the website directory may be converted into a binary tree, it may then be determined whether to add a node of the tree as a segment representing a topic at step 504 to the segmentation. In an embodiment, dynamic programming may be used for determining whether to add a node of the tree as a segment representing a topic to the segmentation. For example, consider S to denote the current solution set. Furthermore, consider C(x, S, k) to be the cost of the best segmentation of the subtree rooted at node x using a budget of k, given that S may be the current solution. Recall that Sₓ, if it may exist, may be the first node along the ordered path from x to the root of the tree T in the current solution S. If Sₓ exists, then nodes in the subtree under x may be covered by Sₓ, with the cost

$${\sum }_{x ∈ leaf ( x )} d ( i , {S}_{x} ) .$$

The dynamic program may be invoked as C(root(T),φ,k). Consider x₁ and x₂ to denote the two children of x. The cost of the best subtree rooted at each of the two children of x using a budget of k/2 may be recursively evaluated until reaching a leaf node. Accordingly, the cost of the best subtree for the dynamic program may be defined as:

$$C ( x , S , k ) = min \{ \begin{matrix} {min}_{{k}^{′} = 1}^{k} ( C ( {x}_{1} , S , {k}^{′} ) + C ( {x}_{2} , S , k - {k}^{′} ) ) \\ \begin{matrix}c ( x , S ) + {min}_{{k}^{′} = 1}^{k - 1} ( C ( {x}_{1} , S ⋃ \{ x \} , {k}^{′} ) + \\ C ( {x}_{2} , S ⋃ \{ x \} , k - {k}^{′} - 1 ) )\end{matrix}\end{matrix} .$$

### The top term may correspond to not choosing x to be in S and the bottom term may correspond to choosing x to be in S.

Upon reaching the leaves in the binary tree, it may be determined whether the leaves in the subtree rooted at an internal node may be assigned to the internal node at step 506. The base case for the dynamic program upon reaching a leaf may be to evaluate C(x,S, k) where x∈leaf(T) and k>0. In an embodiment where leaves may not be included in the solution, the cost of C(x,S,k) may be set to be ∞. In various other embodiments where the leaves of T may be permitted to be part of the solution, the cost may be defined as:

$$C ( x , S , k ) = \{ \begin{matrix} min \{ c ( x , S ) , d ( x , {S}_{x} ) \} & if {S}_{x} exists \\ c ( x , S ) & otherwise\end{matrix} .$$

### Note that if exactly k nodes may be desired in an embodiment, then C(x,S,k) may be set to ∞ whenever k>1.

In the case where there may not be any remaining budget k, the base case for the dynamic program upon reaching a leaf may be to evaluate C(x,S,0) which may be defined as:

$$C ( x , S , 0 ) = \{ \begin{matrix}{\sum }_{{x}^{′} ∈ leaf ( {T}_{x} )} d ( {x}^{′} , {S}_{x} ) & if {S}_{x} exists \\ ∞ & otherwise\end{matrix} .$$

### This may correspond to assigning the leaves in the subtree Tₓ to the node Sₓ, if Sₓ may exist, since there may not be remaining budget in this case.

The result of evaluating the combined cost of adding a node as a segmentation point and the cost of assigning leaves in the subtree rooted at the node to the segment may then be used to complete evaluation of the dynamic program for determining whether to add the subtree rooted at the parent node of the leaf node to the segment. After the nodes of the tree have been added as the k segments, processing may be finished. There may be knd lgΔ entries in the dynamic programming table and each update of an entry may take O(k) time. So, the total running time of the dynamic program may be O(k²nd lg Δ).

Notice that the node selection cost c(·) may be helpful in an embodiment for incorporating heuristic choices and requirements. For instance, setting c(·) to be sufficiently high for two nodes, one of which may be a parent of the other, when the two nodes are very close in distribution, can be used to ensure that nodes added as segments provide extra information to the user.

In an embodiment, the number of segments for the cost function C(x, S, k) may be initialized to a default number. At most k segments may be automatically discovered by running the dynamic program. In practice, the default number of segments may therefore be initialized to be larger than an estimated number of segments expected in the website. For instance, the default number of segments may be initialized to 10 if the expected number of segments may be 7.

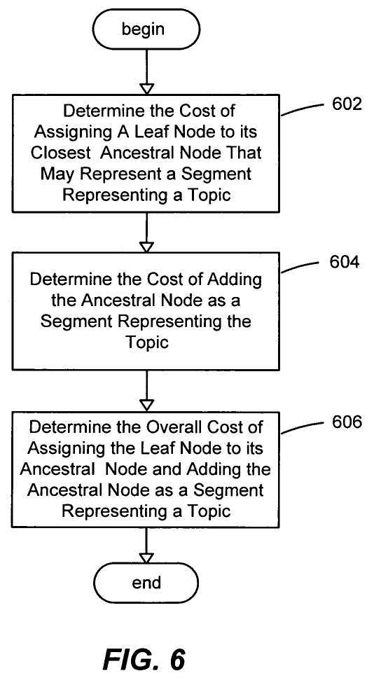

FIG. 6 presents a flowchart generally representing the steps undertaken in one embodiment for determining the overall cost of a particular segmentation of a website converted into a binary tree. At step 602, the cost of assigning a leaf node to its closest ancestral node that may represent a segment representing a topic may be determined. This may represent the cohesiveness cost, d(·). At step 604, the cost of adding the ancestral node as a segment representing a topic to the segmentation solution may be determined. This may represent the node selection cost, c(·). The node selection cost c(·) may represent the penalty for adding a new element into a segmentation S. At step 606, the overall cost of assigning leaf nodes to their closest ancestral nodes that may represent segments representing topics and adding the ancestral nodes as segments representing topics to the segmentation solution may be determined. This may represent the overall cost of

$$β {\sum }_{y ∈ S} c ( y , S ) + ( 1 - β ) {\sum }_{x ∈ leaf ( T )} d ( x , {S}_{x} ) .$$

There may be different variants of the node selection cost c(·)and the cohesiveness cost d(·) that may be used for the equation of the overall cost,

$$β {\sum }_{y ∈ S} c ( y , S ) + ( 1 - β ) {\sum }_{x ∈ leaf ( T )} d ( x , {S}_{x} ) .$$

In an embodiment, the cohesiveness cost measure may be based on the Kullback-Leibler (“KL”)divergence in information theory. For every page x and the node Sₓ to which it may belong, the cohesiveness cost of the assignment of x to Sₓ may be defined to be:

$$\begin{matrix}d ( x , {S}_{x} ) = KL ( {p}_{x} ‖ p {s}_{x} ) \\ = {\sum }_{l ∈ L} {p}_{x} ( l ) log ( \frac{{p}_{x} ( l )}{p {s}_{x} ( l )} ) .\end{matrix}$$

The KL-divergence is the relative entropy of two distributions pₓ and p_{Sx} over an alphabet L that may represent the average number of extra bits needed to encode data drawn from pₓ using a code derived from p_{Sx}. This may correspond to minimizing the wastage in description cost of leaves of the tree using the internal nodes that are selected. Furthermore, using the KL-divergence as a measure of distance may be equivalent to assuming that the class distribution at the leaves may have been generated from a multinomial model over classes at the internal node. (See for example A. Banerjee, S. Merugu, I. S. Dhillon, and J. Ghosh, Clustering with Bregman divergences, Journal Machine Learning Research, 6:1705-1749, 2005.) These properties may make the KL-divergence a good choice for the cohesiveness cost.

In another embodiment, the cohesiveness cost measure may be based on the squared Euclidean distance. The sum of squared Euclidean cost has been extensively used in many applications and may be considered equivalent to modeling the internal node as a multidimensional Gaussian distribution. (See again for example A. Banerjee, S. Merugu, I. S. Dhillon, and J. Ghosh, Clustering with Bregman divergences, Journal Machine Learning Research, 6:1705-1749, 2005.) The distance between a leaf x (web page) and an internal node Sₓ (subdirectory) may be computed using the squared Euclidean distance between the corresponding class distributions, which may be defined to be:

$$\begin{matrix}d ( x , {S}_{x} ) = {‖ {p}_{k} - {ps}_{x} ‖}^{2} \\ = {\sum }_{l ∈ L} {\vert {p}_{x} ( l ) - p {s}_{x} ( l ) \vert}^{2} .\end{matrix}$$

In yet a third embodiment, the cohesiveness cost measure may be based on a cosine cost measure. For instance, the negative cosine dissimilarity measure may be employed as a cohesiveness cost, as follows:

$$\begin{matrix}d ( x , {S}_{x} ) = - ( {p}_{x} , p {s}_{x} ) \\ = {- \sum }_{l ∈ L} {p}_{x} ( l ) p {s}_{x} ( l ) .\end{matrix}$$

The cosine cost measure is well-known in the art for clustering documents in information retrieval. (See, for example, A. Banerjee, I. S. Dhillon, J. Ghosh, and S. Sra, Clustering on the Unit Hypersphere Using von Mises-Fisher Distributions, Journal of Machine Learning Research, 6:1345-1382, 2005.)

In addition to different variants of the cohesiveness cost d(·), there may be different variants of the node selection cost c(·) that may be used for the equation of the overall cost, C(x,S,k)=c(x,S)+d(x,Sₓ). In an embodiment, the node selection cost c(·) may be based on penalizing a node that may be added as a new element of S if it provides little information beyond its closest parent already in the segmentation solution. A related cost measure, referred to as information gain ratio, in the context of decision tree induction was introduced by Quinlan. (See J. R. Quinlan, Induction of Decision Trees, in J. W. Shavlik and T. G. Dietterich, editors, Readings in Machine Learning, Morgan Kaufmann, 1990, originally published in Machine Learning 1:81-106, 1986.) To implement this condition, an α-measure may be defined. Consider, first, T to be a tree consisting of subtrees T₁, . . . , Tₛ. There may be two possible encoding schemes to encode the label of a particular leaf of T. In the first scheme, the label may be communicated using an optimal code based on the distribution of labels in T. In the second scheme, it may first be communicated whether or not the designated leaf lies in T₁, and then the label may be encoded using a tailored code for either T₁ or T \T₁ as appropriate. The second scheme may correspond to adding T₁ to the segmentation. Its overall cost may not be better than the first, but if T₁ may be completely distinct from T \T₁, then the cost of the second scheme may be equivalent to the first. Consider p₁=|T₁|/|T| to be the probability that a uniformly-chosen leaf of T may lie in T₁. Then the cost of communicating whether a leaf may lie within T₁ may be H(p₁). In a worst case, T₁ may look identical to T \T₁ and the second scheme may be H(p₁) bits more expensive than the first. In such a case, the information about the subtree may provide no leverage to the user. The value of subtree T₁ relative to its parent may be characterized, therefore, by asking where on the extreme between H(T) and H(T)+H(p₁) the cost of the second scheme may lie. With this intuition in mind, the cost measure may be formally defined. Consider x to denote the current node considered to be added to the solution S. Recall that Sₓ may be its nearest parent that is already a part of the solution S. Assuming Sₓ exists, consider y to denote Sₓ. Then consider x′ to be a hypothetical node such that leaf(T_{x′})=leaf(T_{y})\leaf(Tₓ), i.e., x′ may include the leaves under the subtree rooted at y but not x. Furthermore, assume n=|leaf(T_{y})|, nₓ=|leaf(Tₓ)|, and n_{x′}=|leaf(T_{x′})|. The split cost for the binary entropy may be defined as H₂(nₓ/n). Using the split cost, the α-measure may be defined to be:

$$α ( x , y ) = \frac{( {n}_{x} / n ) H ( x ) + ( {n}_{{x}^{′}} / n ) H ( {x}^{′} ) + {H}_{2} ( {n}_{x} / n ) - H ( y )}{{H}_{2} ( {n}_{x} / n )} .$$

It may be seen that α may represent values between 0 and 1, with lower values indicating a good split. The cost of adding a node to the solution may then be:

c(x,S)=c(x,y)=α(x,y)·nₓ.

One requirement of using the α-measure in the dynamic program may be to select the root of T, i.e., root(T)∈S, in order to compute the cost of adding additional internal nodes. For some websites, the root directory may contain a large number of files that may not be made part of the solution on their own right and, therefore, may need the root as a selected node to cover them. In general, the α-measure may act as a regularization term in the overall cost function

$$β {\sum }_{y ∈ S} c ( y , S ) + ( 1 - β ) {\sum }_{x ∈ leaf ( T )} d ( x , {S}_{x} )$$

that may regulate the number of segments selected and may help select correct segments.

In practice, varying values of β between 0 and 1 for the equation of overall cost,

$$β {\sum }_{y ∈ S} c ( y , S ) + ( 1 - β ) {\sum }_{x ∈ leaf ( T )} d ( x , {S}_{x} ) ,$$

may result in obtaining solutions with different precision and recall values for manually labeled websites depending upon the combination of cohesiveness cost and node selection cost. Configurations with a higher value of β may find fewer segments in a website than lower values, since higher values of β may bias the over cost function towards not adding a node. Such configurations may be expected to have higher precision but low recall. Configurations with lower values of β may be expected to achieve low precision and higher recall. In some configurations, the combination of the cohesiveness cost measure based on the KL-divergence and the node selection cost measure based on the α-measure may have the desirable property of giving good results over a much larger range of β than using the cohesiveness cost measure based on either the squared Euclidian distance or the cosine cost measure.

Thus the present invention may flexibly provide a framework for incorporating different variants of the node selection cost and the cohesiveness cost to be used. The system and method may apply broadly to provide a simple and concise site-level summary to help users who wish to understand the overall content and focus of a particular website amenable to hierarchical segmentation by topic. Moreover, the system and method may be applied to extend existing online search applications which may provide a link to a topic within a topically-focused segment of a large directory. Furthermore, a topical segmentation may provide a useful guide to determine the appropriate granularity of a site hosting many aggregated individual websites. Those skilled in the art will appreciate that topical segmentation may be applicable for these and other applications, such as website classification.

As can be seen from the foregoing detailed description, the present invention provides an improved system and method for hierarchical segmentation of websites by topic. An organization of topics may be determined within directories of a website, the hierarchical arrangement of the web pages in the website may be segmented by topic, and the segments representing regions of coherent topics in the website directory may be output. The present invention also provides a set of cost measures characterizing the benefit accrued by introducing a segmentation of the website based on topics. Advantageously, the present invention may thus provide a flexible framework to allow implementations incorporating specific heuristic choices and requirements. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for segmenting a website, comprising:
storage for storing a location of a subdirectory of a directory of a website segmented by topics, the location of the subdirectory representing a segment of a directory associated with content about a particular topic;
a segmentation engine operably coupled to the storage for segmenting the directory into a plurality of segments associated with different topics; and
a cost analysis engine operably coupled to the segmentation engine for analyzing a cost of adding the subdirectory as the segment to a segmentation of the website.

2. The system of claim 1 further comprising a node selection cost analyzer operably coupled to the cost analysis engine for determining a cost of adding a node of the website directory as the segment to a segmentation of the website.

3. The system of claim 1 further comprising a cohesiveness cost analyzer for determining a cost of assigning a web page of the website directory to a subdirectory indicated as the segment.

4. A computer-readable medium having computer-executable components comprising the system of claim 1.

5. A computer-implemented method for segmenting a website, comprising:
determining an organization of topics within a directory of a website;
segmenting the directory of the website by topics into subdirectories, each subdirectory representing a segment associated with a different topic; and
outputting segments of the website representing different topics.

6. The method of claim 5 further comprising converting the website directory into a binary tree.

7. The method of claim 5 wherein segmenting the directory of the website by topics into subdirectories comprises determining whether to add a subdirectory of the directory of the website as a segment representing a topic.

8. The method of claim 5 wherein segmenting the directory of the website by topics into subdirectories comprises determining whether to assign a web page of the directory of the website to a segment representing a topic.

9. The method of claim 7 wherein determining whether to add a subdirectory of the directory of the website as a segment representing a topic comprises evaluating a node selection cost of adding the subdirectory as the segment representing the topic.

10. The method of claim 8 wherein determining whether to assign a web page of the directory of the website to a segment representing a topic comprises evaluating a cohesiveness cost of assigning the web page to a subdirectory representing the segment representing the topic.

11. The method of claim 9 wherein evaluating a node selection cost of adding the subdirectory as the segment representing the topic comprises evaluating an α-measure representing an information gain ratio.

12. The method of claim 10 wherein evaluating a cohesiveness cost of assigning the web page to a subdirectory representing the segment representing the topic comprises evaluating a cost measure based on a Kullback-Leibler divergence.

13. The method of claim 10 wherein evaluating a cohesiveness cost of assigning the web page to a subdirectory representing the segment representing the topic comprises evaluating a cost measure based on a squared Euclidean distance.

14. The method of claim 10 wherein evaluating a cohesiveness cost of assigning the web page to a subdirectory representing the segment representing the topic comprises evaluating a cost measure based on a cosine cost measure.

15. A computer-readable medium having computer-executable instructions for performing the method of claim 5.

16. A computer system for segmenting a website, comprising:
means for assigning topics to content of a website;
means for segmenting the website by topic; and
means for outputting the segments of the website by topic.

17. The computer system of claim 16 wherein means for segmenting the website by topic comprises:
means for converting the website directory into a binary tree;
means for determining whether to add an internal node of the binary tree as a segment representing a topic; and
means for determining whether to assign a leaf node of the binary tree to the segment representing the topic.

18. The computer system of claim 16 wherein means for segmenting the website by topic comprises means for determining a cost of adding a subdirectory of the website directory as a segment representing a topic.

19. The computer system of claim 16 wherein means for segmenting the website by topic comprises means for determining a cost of assigning a web page of the directory of the website to a segment representing a topic.

20. The computer system of claim 16 wherein means for segmenting the website by topic comprises:
means for evaluating a node selection cost of adding a subdirectory of the website as a segment representing the topic; and
means for evaluating a cohesiveness cost of assigning a web page of the subdirectory to the segment representing the topic.
